(19) United States
(12) Patent Application Publication
(10) Pub. No.: US 2026/0264678 A1
(43) Pub. Date: Sep. 10, 2026

(54) VEHICLE CONTROL DEVICE, VEHICLE CONTROL METHOD, AND PROGRAM

(71) Applicant: HONDA MOTOR CO., LTD., Minato-ku, Tokyo (JP)

(72) Inventors: Haruhiko Nishiguchi, Tokyo (JP); Shingo Ito, Tokyo (JP)

(21) Appl. No.: 19/166,495

(22) PCT Filed: Mar. 20, 2023
(86) PCT No.: PCT/JP2023/010899

§ 371 Date: Sep. 18, 2025

(51) Int. Cl. B60W 30/14; B60W 10/20; B60W 40/08; G06V 20/59; G06V 40/10

(52) U.S. Cl. CPC B60W 30/143; B60W 10/20; B60W 40/08; G06V 20/597; G06V 40/11; B60W 2420/403; B60W 2540/223; B60W 2552/30

(57) ABSTRACT

A vehicle control device causes a vehicle to travel according to a first speed plan in a case where a driver is gripping the steering wheel and causes the vehicle to travel according to a second speed plan for causing the vehicle to travel at a speed lower than a speed according to the first speed plan in a case where the driver is not gripping the steering wheel while the vehicle is traveling on a curved road. The first speed plan and the second speed plan are information indicating transition of a speed of the vehicle when traveling on the curved road. The second speed plan is switched to the first speed plan and the vehicle is caused to travel on the basis of the first speed plan when it is determined that the driver has gripped the steering wheel.

### TECHNICAL FIELD

The present invention relates to a vehicle control device, a vehicle control method, and a program.

### BACKGROUND ART

In recent years, efforts to realize vehicle control taking vehicle occupants, traffic participants, and the like into account have become active. In the related art, a traveling control device for a vehicle controlling a target vehicle speed in accordance with a steering wheel grip state when traveling on a curve has been disclosed (for example, refer to Patent Document 1). This traveling control device prevents vehicle occupants from feeling uneasy by performing the foregoing control.

### Citation List

### Patent Document

Patent Document 1: Japanese Unexamined Patent Application, First Publication No. 2017-144776

### SUMMARY OF INVENTION

### Technical Problem

However, there have been cases where the foregoing traveling control device could not realize control that suits the feeling of vehicle occupants. The foregoing traveling control device may not sufficiently take occupants into account and may not sufficiently contribute to development of sustainable transportation systems.

The present invention has been made in consideration of such circumstances, and an object thereof is to provide a vehicle control device, a vehicle control method, and a program, in which control that suits the feeling of vehicle occupants can be performed. This will be able to ultimately contribute to development of sustainable transportation systems while taking occupants into account.

### Solution to Problem

A vehicle control device, a vehicle control method, and a program according to this invention employ the following constitutions.
(1): A vehicle control device according to an aspect of this disclosure includes a recognizer recognizing surrounding circumstances of a vehicle, a determiner determining whether or not a driver of the vehicle is gripping a steering wheel of the vehicle, and a controller controlling a speed of the vehicle and steering of the vehicle on the basis of the surrounding circumstances. The controller causes the vehicle to travel according to a first speed plan in a case where the driver is gripping the steering wheel and causes the vehicle to travel according to a second speed plan for causing the vehicle to travel at a speed lower than a speed according to the first speed plan in a case where the driver is not gripping the steering wheel while the vehicle is traveling on a curved road. The first speed plan and the second speed plan are information indicating transition of the speed of the vehicle when traveling on the curved road. The second speed plan is switched to the first speed plan and the vehicle is caused to travel on the basis of the first speed plan when it is determined that the driver has gripped the steering wheel in a case where the driver is not gripping the steering wheel and the vehicle is caused to travel on the curved road according to the second speed plan.
(2): According to the aspect of the foregoing (1), the controller restrains a deceleration degree of the vehicle or accelerates the vehicle to cause the speed of the vehicle to match a speed prescribed in the first speed plan when the driver grips the steering wheel in a case where the speed of the vehicle is controlled on the basis of the second speed plan.
(3): According to the aspect of the foregoing (1) or (2), the controller causes the vehicle to travel at a first speed according to the first speed plan in a case where the driver is gripping the steering wheel while the vehicle is traveling on a curved road, causes the vehicle to travel at a second speed according to the second speed plan lower than the first speed in a case where the driver is not gripping the steering wheel while the vehicle is traveling on a curved road, and accelerates the vehicle to the first speed when it is determined that the driver has changed from a state of not gripping the steering wheel to a state where the driver is gripping the steering wheel while the vehicle is traveling at the second speed.
(4): According to the aspect of the foregoing (2), the controller accelerates the vehicle to a first speed according to the first speed plan at a first acceleration degree when the driver is gripping the steering wheel while the vehicle is traveling according to the second speed plan and before the vehicle reaches a first reference location set on the basis of an exit of a curve or a spot near the exit of a curve, and accelerates the vehicle to the first speed at a second acceleration degree which is gentler than the first acceleration degree when the driver is gripping the steering wheel while the vehicle is traveling according to the second speed plan and after the vehicle has reached the first reference location.
(5): According to the aspect of the foregoing (4), the controller causes the vehicle to travel according to the first speed plan in a case where the driver is gripping the steering wheel while the vehicle is traveling on a curved road and accelerates the vehicle in a case where the vehicle has reached a second reference location set on the basis of an exit of a curve or a spot near the exit of a curve, accelerates the vehicle to the first speed at the first acceleration degree in a case where a time period from a first time to a second time is equal to or longer than a threshold when the driver is gripping the steering wheel while the vehicle is traveling according to the second speed plan and accelerates the vehicle at the second acceleration degree in a case where the time period from the first time to the second time is shorter than the threshold when the driver is gripping the steering wheel while the vehicle is traveling according to the second speed plan. The first time is a time when the speed of the vehicle reaches the first speed in a case where it is assumed that the vehicle is accelerated at the first acceleration degree.

The second time is a time when the vehicle reaches the second reference location in a case where the vehicle has traveled at the first speed from the first time.
(6): According to the aspect of the foregoing (1) or (2), the controller decelerates the vehicle to a first speed according to the first speed plan in a case where the driver is gripping the steering wheel while the vehicle is traveling on a curved road, decelerates the vehicle to a second speed according to the second speed plan lower than the first speed in a case where the driver is not gripping the steering wheel while the vehicle is traveling on a curved road, and accelerates the vehicle or restrains a degree of deceleration when it is determined that the driver has gripped the steering wheel in a case where the driver is not gripping the steering wheel and the vehicle is decelerated to be closer to the second speed while the vehicle is traveling on a curved road.
(7): According to the aspect of the foregoing (6), in a case where the driver is not gripping the steering wheel and the vehicle is decelerated to be closer to the second speed while the vehicle is traveling on a curved road, the controller decelerates the vehicle to the first speed instead of decelerating the vehicle to the second speed in a case where the driver is not gripping the steering wheel and the vehicle is decelerated to be closer to the second speed.
(8): According to the aspect of the foregoing (6), in a case where the driver is gripping the steering wheel and the speed of the vehicle is lower than the first speed while the vehicle is traveling on a curved road, the controller accelerates the vehicle to the first speed in a case where the driver is not gripping the steering wheel and the vehicle is decelerated to be closer to the second speed.
(9): According to the aspect of the foregoing (8), the controller accelerates the vehicle to the first speed according to the first speed plan at a first acceleration degree when the driver is gripping the steering wheel while the vehicle is decelerated to be closer to the second speed according to the second speed plan and before the vehicle reaches a first reference location set on the basis of an exit of a curve or a spot near the exit of a curve, and accelerates the vehicle to the first speed at a second acceleration degree which is gentler than the first acceleration degree when the driver is gripping the steering wheel while the vehicle is decelerated to be closer to the second speed and after the vehicle has reached the first reference location.
(10): According to the aspect of the foregoing (9), the controller causes the vehicle to travel at the first speed in a case where the driver is gripping the steering wheel while the vehicle is traveling on a curved road and accelerates the vehicle in a case where the vehicle has reached a second reference location set on the basis of an exit of a curve or a spot near the exit of a curve, accelerates the vehicle to the first speed at the first acceleration degree in a case where a time period from a first time to a second time is equal to or longer than a threshold when the vehicle is decelerated to be closer to the second speed and the driver is gripping the steering wheel, and accelerates the vehicle at the second acceleration degree in a case where the time period from the first time to the second time is shorter than the threshold when the vehicle is decelerated to be closer to the second speed and the driver is gripping the steering wheel. The first time is a time when the speed of the vehicle reaches the first speed in a case where it is assumed that the vehicle is accelerated at the first acceleration degree. The second time is a time when the vehicle reaches the second reference location in a case where the vehicle has traveled at the first speed from the first time.
(11): According to the aspect of the foregoing (1) or (2), the first speed plan is a plan in which the speed of the vehicle is decelerated to a first speed, the vehicle is caused to travel at the first speed during a first time period, and then the vehicle is accelerated. The controller causes the speed of the vehicle to follow a speed prescribed in the first speed plan at the time of (i) and causes the speed of the vehicle to follow a speed prescribed in a speed plan different from the first speed plan at the time of (ii) when the driver is gripping the steering wheel and the speed of the vehicle is lower than the speed prescribed in the first speed plan in a case where the vehicle is caused to travel on the basis of the second speed plan, in which (i) indicates that a time period from a first time point when the speed of the vehicle has reached the first speed to an end point of the first time period is equal to or longer than a threshold in a case where it is assumed that the speed of the vehicle is caused to match the first speed at a predetermined acceleration degree and (ii) indicates that the time period from the first time point when the speed of the vehicle has reached the first speed to the end point of the first time period is shorter than the threshold in a case where it is assumed that the speed of the vehicle is caused to match the first speed at the predetermined acceleration degree.
(12): In a vehicle control method according to another aspect of the present invention, a computer executes processing of recognizing surrounding circumstances of a vehicle, processing of determining whether or not a driver of the vehicle is gripping a steering wheel of the vehicle, processing of controlling a speed of the vehicle and steering of the vehicle on the basis of the surrounding circumstances, processing of causing the vehicle to travel according to a first speed plan in a case where the driver is gripping the steering wheel and causing the vehicle to travel according to a second speed plan for causing the vehicle to travel at a speed lower than a speed according to the first speed plan in a case where the driver is not gripping the steering wheel while the vehicle is traveling on a curved road, in which the first speed plan and the second speed plan are information indicating transition of the speed of the vehicle when traveling on the curved road, and processing of switching the second speed plan to the first speed plan and causing the vehicle to travel on the basis of the first speed plan when it is determined that the driver has gripped the steering wheel in a case where the driver is not gripping the steering wheel and the vehicle is caused to travel on the curved road according to the second speed plan.
(13): A program according to another aspect of the present invention causes a computer to execute processing of recognizing surrounding circumstances of a vehicle, processing of determining whether or not a driver of the vehicle is gripping a steering wheel of the vehicle, processing of controlling a speed of the vehicle and steering of the vehicle on the basis of the surrounding circumstances, processing of causing the vehicle to travel according to a first speed plan in a case where the driver is gripping the steering wheel and causing the vehicle to travel according to a second speed plan for causing the vehicle to travel at a speed lower than a speed according to the first speed plan in a case where the driver is not gripping the steering wheel while the vehicle is traveling on a curved road, in which the first speed plan and the second speed plan are information indicating transition of the speed of the vehicle when traveling on the curved road, and processing of switching the second speed plan to the first speed plan and causing the vehicle to travel on the basis of the first speed plan when it is determined that the driver has gripped the steering wheel in a case where the driver is not gripping the steering wheel and the vehicle is caused to travel on the curved road according to the second speed plan.

### Advantageous Effects of Invention

According to the aspects of the foregoing (1) to (13), the vehicle control device, the vehicle control method, and the program can realize driving assistance that suits the feeling of occupants. Accordingly, the comfort of vehicle occupants can be improved.

According to the aspect of the foregoing (2), since the vehicle control device performs a deceleration or an acceleration in accordance with a steering wheel grip state of a driver, safety and driving assistance that suits the feeling of occupants can be realized.

According to the aspects of the foregoing (4), (5), (9), and (10), the vehicle control device can perform an acceleration causing no uncomfortable feeling to occupants.

### BRIEF DESCRIPTION OF DRAWINGS

FIG. 1 A view of a constitution of a vehicle system 1 utilizing a vehicle control system according to an embodiment.

FIG. 2 An explanatory view of speed adjustment control.

FIG. 3 An explanatory view of a state of a driver and information provided via an HMI.

FIG. 4 An explanatory view of the speed adjustment control (part 1).

FIG. 5 An explanatory view of the speed adjustment control (part 2).

FIG. 6 A flowchart showing an example of a flow of processing executed by a driving assistance device (part 1).

FIG. 7 A flowchart showing an example of a flow of processing executed by the driving assistance device (part 2).

FIG. 8 An explanatory view of control in a case of a hands-on state during speed adjustment (part 1).

FIG. 9 An explanatory view of control in a case of the hands-on state during

speed adjustment (part 2).

FIG. 10 An explanatory view of control in a case of the hands-on state during speed adjustment (part 3).

FIG. 11 A view showing an example of being controlled to a first speed.

FIG. 12 A view showing an example of being controlled to a target speed.

FIG. 13 An explanatory view of a first reference location.

FIG. 14 A flowchart showing an example of a flow of processing executed by the driving assistance device (part 3).

### DESCRIPTION OF EMBODIMENT

Hereinafter, with reference to the drawings, an embodiment of a vehicle control device, a vehicle control method, and a program according to the present invention will be described.

### Embodiment

### Overall Constitution

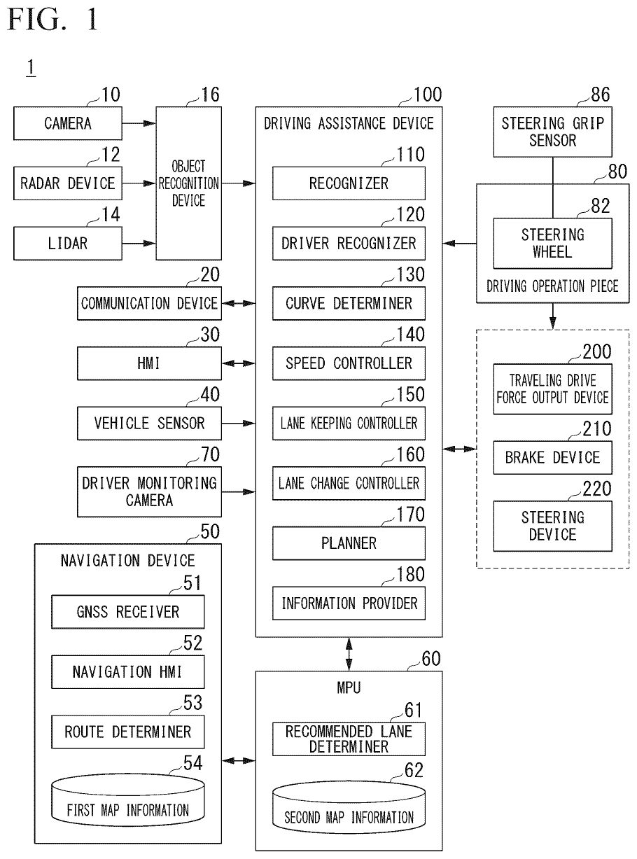

FIG. 1 is a view of a constitution of a vehicle system 1 utilizing a vehicle control system according to an embodiment. For example, a vehicle having the vehicle system 1 mounted therein is a vehicle having two wheels, three wheels, four wheels, or the like, and a drive source thereof is an internal-combustion engine such as a diesel engine or a gasoline engine, an electric motor, or a combination of these. An electric motor is operated using power generated by a generator connected to an internal-combustion engine, or discharge power of a secondary battery or a fuel cell.

For example, the vehicle system 1 includes a camera 10, a radar device 12, a light detection and ranging (LIDAR) 14, an object recognition device 16, a communication device 20, a human machine interface (HMI) 30, a vehicle sensor 40, a navigation device 50, an MPU 60, a driver monitoring camera 70, a driving operation piece 80, a driving assistance device 100, a traveling drive force output device 200, a brake device 210, and a steering device 220. These devices and instruments are connected to each other through a multiplex communication line such as a controller area network (CAN) communication line, a serial communication line, a wireless communication network, or the like. The constituents shown in FIG. 1 are merely an example. Some of the constituents may be omitted, and other constituents may further be added thereto.

For example, the camera 10 is a digital camera utilizing a solid-state image capturing element such as a charge coupled device (CCD) or a complementary metal oxide semiconductor (CMOS). The camera 10 is attached to an arbitrary part in a vehicle having the vehicle system 1 mounted therein (hereinafter, a host vehicle M).

When images on the side in front are captured, the camera 10 is attached to an upper part of a front windshield, a rear surface of a rearview mirror, or the like. For example, the camera 10 captures images around the host vehicle M periodically and repeatedly. The camera 10 may be a stereo camera.

The radar device 12 radiates radio waves such as millimeter waves around the host vehicle M and detects at least the location (distance and azimuth) of an object by detecting radio waves (reflected waves) reflected by the object. The radar device 12 is attached to an arbitrary part in the host vehicle M. The radar device 12 may detect the location and the speed of an object by a frequency modulated continuous wave (FM-CW) method.

The LIDAR 14 emits light (or electromagnetic waves having a wavelength close to that of light) around the host vehicle M and measures scattered light. The LIDAR 14 detects the distance to a target on the basis of the time period from light emission to light reception. For example, emitted light is pulsed laser light. The LIDAR 14 is attached to an arbitrary part in the host vehicle M.

The object recognition device 16 recognizes the location, the kind, the speed, and the like of an object by performing sensor fusion processing with respect to detection results of some or all of the camera 10, the radar device 12, and the LIDAR 14. The object recognition device 16 outputs recognition results to the driving assistance device 100. The object recognition device 16 may output the detection results of the camera 10, the radar device 12, and the LIDAR 14 to the driving assistance device 100 without any change. The object recognition device 16 may be omitted from the vehicle system 1.

For example, the communication device 20 communicates with other vehicles present around the host vehicle M utilizing a cellular network, a Wi-Fi network, Bluetooth (registered trademark), dedicated short range communication (DSRC), or the like or communicates with various server devices via a wireless base station.

The HMI 30 provides various information to an occupant of the host vehicle M and receives an input operation of the occupant. The HMI 30 includes various display devices, a speaker, a buzzer, a touch panel, a switch, a key, and the like. The HMI 30 includes a display device. For example, the display device (display) is a display device (so-called multi-information display) provided in a central part of an instrument panel of the host vehicle M and displaying various information on the host vehicle M, such as a speedometer showing a traveling speed of the host vehicle M and a tachometer showing a rotation frequency (rotational speed) of an internal-combustion engine provided in the host vehicle M.

The vehicle sensor 40 includes a vehicle speed sensor for detecting a speed of the host vehicle M, an acceleration degree sensor for detecting an acceleration degree, a yaw rate sensor for detecting an angular velocity around a vertical axis, an azimuth sensor for detecting a direction of the host vehicle M, and the like.

For example, the navigation device 50 includes a global navigation satellite system (GNSS) receiver 51, a navigation HMI 52, and a route determiner 53. In the navigation device 50, first map information 54 is retained in a storage device such as a hard disk drive (HDD) or a flash memory. The GNSS receiver 51 identifies the location of the host vehicle M on the basis of a signal received from a GNSS satellite. The location of the host vehicle M may be identified or completed by an inertial navigation system (INS) utilizing an output of the vehicle sensor 40. The navigation HMI 52 includes a display device, a speaker, a touch panel, a key, and the like. Some or all of the navigation HMI 52 may be shared by the HMI 30 described above. For example, the route determiner 53 determines a route from the location of the host vehicle M identified by the GNSS receiver 51 (or an arbitrary input location) to a destination input by the occupant (hereinafter, a route on the map) using the navigation HMI 52 with reference to the first map information 54. For example, the first map information 54 is information in which road shapes are expressed by links indicating roads and nodes connected by the links. The first map information 54 may include curvatures of roads, point-of-interest (POI) information, and the like. The route on the map is output to the MPU 60. The navigation device 50 may perform route guidance using the navigation HMI 52 on the basis of the route on the map. For example, the navigation device 50 may be realized by a function of a terminal device such as a smartphone or a tablet terminal possessed by the occupant. The navigation device 50 may transmit a current location and a destination to a navigation server via the communication device 20 and acquire a route equivalent to the route on the map from the navigation server.

For example, the MPU 60 includes a recommended lane determiner 61 and retains second map information 62 in a storage device such as an HDD or a flash memory. The recommended lane determiner 61 divides the route on the map provided from the navigation device 50 into a plurality of blocks (for example, divides it into blocks of 100 [m] in a vehicle proceeding direction) and determines a recommended lane for each block with reference to the second map information 62. The recommended lane determiner 61 determines in which lane from the left the vehicle should travel.

When there is a branch point in the route on the map, the recommended lane determiner 61 determines a recommended lane such that the host vehicle M can travel along a reasonable route to proceed to a branch destination.

The second map information 62 is map information that is more accurate than the first map information 54. For example, the second map information 62 includes information of the center of a lane, information of the boundary of a lane, and the like. The second map information 62 may include road information, traffic regulation information, address information (address, postal code), facility information, telephone number information, and the like. The second map information 62 may be updated at any time by the communication device 20 through communication with other devices.

For example, the driver monitoring camera 70 is a digital camera utilizing a solid-state image capturing element such as a CCD or a CMOS. The driver monitoring camera 70 is attached to an arbitrary part in the host vehicle M in a location and a direction in which images of the head of the occupant seated in a driver's seat (hereinafter, a driver) of the host vehicle M can be captured from the front (in a direction in which images of the face are captured). For example, the driver monitoring camera 70 is attached to an upper part of the display device provided in the central part of an instrument panel of the host vehicle M. The driver monitoring camera 70 outputs images of the interior of the vehicle including the driver of the host vehicle M captured from the disposed location to the driving assistance device 100.

For example, the driving operation piece 80 includes a steering wheel 82 as well as a direction indicator operation switch, an accelerator pedal, a brake pedal, a shift lever, and other operation pieces. A sensor for detecting an amount of operation or whether there is an operation is attached to the driving operation piece 80, and detection results thereof are output to some or all of the driving assistance device 100, the traveling drive force output device 200, the brake device 210, and the steering device 220. The steering wheel 82 does not necessarily have to have an annular shape and may be in a form of a deformed steering wheel, a joystick, a button, or the like. A steering grip sensor 86 is attached to the steering wheel 82.

For example, the steering grip sensor 86 is realized by an electrostatic capacitance sensor, a piezoelectric element, or the like. The steering grip sensor 86 detects whether or not the driver is in a state of gripping the steering wheel 82. Gripping indicates a state where the driver is grasping the steering wheel, a state where the hand is in contact with the steering wheel and a force of a predetermined degree or greater is being applied to the steering wheel, and the like.

The steering grip sensor 86 may detect a grip on the basis of images captured by the camera or detect a grip using an optical technique, such as a radar device (technique not requiring contact with the sensor).

For example, the driving assistance device 100 includes a recognizer 110, a driver recognizer 120, a curve determiner 130, a speed controller 140, a lane keeping controller 150, a lane change controller 160, a planner 170, and an information provider 180. For example, some or all of these functioning parts are realized by a hardware processor such as a central processing unit (CPU) executing a program (software). Some or all of these constituent elements may be realized by hardware (circuit; including circuitry) such as a large scale integration (LSI), an application specific integrated circuit (ASIC), a field-programmable gate array (FPGA), a graphics processing unit (GPU), or a system on chip (SOC), or may be realized by software and hardware in cooperation. The program may be stored in a storage device such as an HDD or a flash memory (a storage device including a non-transitory storage medium) of the driving assistance device 100 in advance or may be stored in an attachable/detachable storage medium such as a DVD or a CD-ROM such that the program is installed in the HDD or the flash memory of the driving assistance device 100 when the storage medium (non-transitory storage medium) is mounted in a drive device.

The recognizer 110 recognizes the state of an object around the host vehicle M, such as the location, the speed, the acceleration degree, and the like, on the basis of information input from the camera 10, the radar device 12, and the LIDAR 14 via the object recognition device 16. For example, the location of an object is recognized as a location on absolute coordinates with an origin at a representative point (centroid, drive shaft center, or the like) in the host vehicle M and is used for control. The location of an object may be expressed by a representative point such as the centroid or a corner of the object or may be expressed as a region. The “state” of an object may include an acceleration degree or a jerk of the object or “a behavior state” (for example, whether or not it is making a lane change or attempting a lane change).

For example, the recognizer 110 recognizes a lane in which the host vehicle M is traveling (traveling lane). For example, the recognizer 110 recognizes a traveling lane by comparing the pattern of a road division line (for example, an array of solid lines and dashed line) obtained from the second map information 62 with the pattern of the road division line around the host vehicle M recognized from images captured by the camera 10. The recognizer 110 may recognize a traveling lane by recognizing traveling path boundaries (road boundaries) including road division lines, road shoulders, curbstones, median strips, guardrails, and the like without being limited to road division lines. In this recognition, the location of the host vehicle M acquired from the navigation device 50 or processing results of the INS may be added. The recognizer 110 recognizes stop lines, obstacles, red lights, toll gates, and other road events.

When recognizing a traveling lane, the recognizer 110 recognizes the location or the posture of the host vehicle M with respect to the traveling lane. For example, the recognizer 110 may recognize the deviation of a reference point in the host vehicle M from the center of the lane and the angle formed with respect to a line of the centers of the lane of the host vehicle M in the proceeding direction as the relative location and posture of the host vehicle M with respect to the traveling lane. Instead of this, the recognizer 110 may recognize the location or the like of the reference point in the host vehicle M with respect to any side end part (a road division line or a road boundary) of the traveling lane as the relative location of the host vehicle M with respect to the traveling lane.

The driver recognizer 120 detects whether or not the driver is in a predetermined state on the basis of images captured by the driver monitoring camera 70. A predetermined state indicates a state where hands-off lane keeping control (which will be described below) can be executed. A hands-off state indicates a state where the driver is not gripping the steering wheel, and a hands-on state indicates a state where the driver is gripping the steering wheel. A state where the hands-off lane keeping control can be executed indicates a state where the driver is monitoring ahead (or surroundings of the host vehicle M). For example, monitoring ahead denotes that the driver is monitoring ahead such that the driver can quickly take over from control of the host vehicle M by the vehicle system 1 to operation of the host vehicle M by the driver. For example, monitoring ahead denotes that the visual line of the driver is directed forward.

The curve determiner 130 identifies the location of the host vehicle M in the map information on the basis of the map information including information related to lanes (the first map information 54 or the second map information 62) and the location of the host vehicle M. The map information includes information indicating the features of the roads and the traveling lanes. For example, the information indicating the features includes radii of circles of curves (curve radii). The information indicating the features may include information indicating whether a curved road is a curved road where “speed adjustment control” (which will be described below) can be executed. Curved roads may include roads which are curved, and roads in a region within a predetermined distance from the roads. For example, a region within a predetermined distance denotes a region corresponding to the location where the host vehicle M decelerates when entering a curve.

The speed controller 140 automatically controls the speed of the host vehicle M by automatically controlling the traveling drive force output device 200 and the brake device 210 without relying on an operation of the driver. The speed controller 140 executes adaptive cruise control (ACC).

For example, when there are no other vehicles in front of the host vehicle M within a predetermined distance from the host vehicle M, the speed controller 140 automatically controls the traveling drive force output device 200 and the brake device 210 without relying on an operation of the driver such that the host vehicle M moves at a speed set by the driver, the legal speed, or a speed set in advance in accordance with the road.

For example, when there are other vehicles in front of the host vehicle M within a predetermined distance from the host vehicle M, the speed controller 140 automatically controls the traveling drive force output device 200 and the brake device 210 without relying on an operation of the driver so as to follow other vehicles. Following denotes that the host vehicle M travels behind another vehicle while maintaining the location at a predetermined distance from this vehicle. The speed controller 140 performs speed adjustment control, which will be described below.

The lane keeping controller 150 controls the steering device 220 such that the host vehicle M does not deviate from the traveling lane. For example, the lane keeping controller 150 controls the steering device 220 such that the host vehicle M travels at the center or near the center of the traveling lane recognized by the recognizer 110. Hereinafter, this control may be referred to as “lane keeping control”. The lane keeping controller 150 executes hands-on lane keeping control and hands-off lane keeping control.

The hands-on lane keeping control is control executed in a state where the driver is gripping the steering wheel (a state where the steering grip sensor 86 has detected a grip on the steering wheel). The conditions under which the hands-on lane keeping control can be executed are less strict than the conditions under which the hands-off lane keeping control can be executed. For example, the hands-on lane keeping control is executed if the speed of the host vehicle M is equal to or higher than a predetermined speed and the driver is monitoring ahead.

The hands-off lane keeping control is control executed in a state where the driver is not gripping the steering wheel (a state where the steering grip sensor 86 has not detected a grip on the steering wheel). For example, the hands-off lane keeping control can be executed when the following conditions are satisfied: the speed of the host vehicle M is equal to or higher than a predetermined speed, the host vehicle M is traveling on a predetermined road (for example, a road or a type of a road which has been set in advance such that the hands-off lane keeping control can be executed), and the driver is monitoring ahead. The hands-off lane keeping control is executed when the driver is monitoring ahead, and the hands-off lane keeping control is not executed or stops when the driver is not monitoring ahead.

The conditions under which the hands-on lane keeping control and the hands-off lane keeping control described above can be executed are examples, and other conditions (for example, the host vehicle M is following a preceding vehicle) may be included or some conditions may be omitted. The conditions under which the hands-on lane keeping control can be executed need only be less strict than the conditions under which the hands-off lane keeping control can be executed (the conditions under which the hands-off lane keeping control can be executed need only be stricter than the conditions under which the hands-on lane keeping control can be executed).

The lane change controller 160 causes the host vehicle M to automatically perform a lane change. The lane change controller 160 causes the host vehicle M to perform a lane change on the basis of a destination or a route set by the occupant, or a recommended lane output to the MPU 60. For example, when a lane change is necessary to proceed to a destination, the lane change controller 160 performs a lane change. In a state where the hands-off lane keeping control is being executed, when a lane change is instructed by the driver, the lane change controller 160 causes the host vehicle M to automatically perform a lane change (ALC; auto lane change). An instruction of a lane change is an operation of a lever of the direction indicator operation switch. For example, if the driver operates the lever in a direction in which he or she wishes to perform a lane change of the host vehicle M, the host vehicle M performs a lane change in the direction corresponding to the operation. An instruction of a lane change may be an operation different from an operation of the lever of the direction indicator operation switch. For example, a lane change may be performed when a predetermined operation button is pressed.

For example, the lane change controller 160 executes a lane change when the following conditions are satisfied. For example, the conditions are that there is no obstacle in the lane of a lane change destination, there is no interference with other vehicles around when a lane change is performed, the area is not a section prohibiting lane changes (there are no road markings or road signs prohibiting lane changes), the lane of a lane change destination has been recognized (is actually present), the yaw rate detected by the vehicle sensor 40 is lower than a threshold, the radius of curvature of the traveling road is equal to or larger than a predetermined value, and the like. The conditions for executing a lane change may include other conditions, or some of the conditions may be omitted.

For example, the lane change controller 160 may execute a lane change on condition that the driver is gripping the steering wheel (the steering grip sensor 86 has detected a grip on the steering wheel).

The planner 170 generates a plan for causing the host vehicle M to travel on the basis of a route set by the occupant, along which the host vehicle M proceeds to a destination. In principle, the planner 170 generates a target trajectory in which the host vehicle M will travel automatically (without relying on an operation of the driver) in the future so as to travel in a recommended lane determined by the recommended lane determiner 61 and further be able to cope with the surrounding circumstances of the host vehicle M. For example, a target trajectory may include a speed element. For example, a target trajectory is expressed as an ordered sequence of spots (trajectory points) which the host vehicle M should reach. The trajectory points are spots which the host vehicle M should reach at intervals of a predetermined traveling distance (for example, approximately several [m]) along a road, and separately from this, a target speed and a target acceleration degree at intervals of a predetermined sampling time period (for example, approximately a few tenths of [sec]) are generated as part of the target trajectory. The trajectory points may be locations set at intervals of a predetermined sampling time period and which the host vehicle M should reach at each sampling time. In this case, information of the target speed and the target acceleration degree is expressed by the intervals between the trajectory points.

For example, the planner 170 causes the host vehicle M to travel along the target trajectory in association with the curve determiner 130, the speed controller 140, the lane keeping controller 150, and the lane change controller 160. For example, in a state where the driver of the host vehicle M is monitoring the surroundings of the host vehicle M, the planner 170 generates a plan for behavior of the host vehicle M such that the speed controller 140 controls the speed of the host vehicle M, the lane keeping controller 150 controls steering, and the driver controls the speed, grips the steering wheel, or operates the steering wheel as necessary to reach a destination. For example, the planner 170 generates a plan to cause the host vehicle M to travel under an operation of the driver in a first section and cause the host vehicle M to travel under control of the driving assistance device 100 in a second section, and the host vehicle M is caused to travel in association with the driver, the curve determiner 130, the speed controller 140, the lane keeping controller 150, and the lane change controller 160 in accordance with the plan.

The information provider 180 causes the HMI 30 to output various information related to the state of the host vehicle M and driving assistance in a form of audio or images.

The traveling drive force output device 200 outputs a traveling drive force (torque) for the host vehicle M to travel to driving wheels. For example, the traveling drive force output device 200 includes a combination of an internal-combustion engine, an electric motor, a transmission, and the like, and an ECU for controlling these. The ECU controls the foregoing constituents in accordance with the information input from the speed controller 140 or the information input from the driving operation piece 80.

For example, the brake device 210 includes a brake caliper, a cylinder transmitting hydraulic pressure to the brake caliper, an electric motor generating the hydraulic pressure in the cylinder, and a brake ECU. The brake ECU controls the electric motor in accordance with the information input from the speed controller 140 or the information input from the driving operation piece 80 so that a brake torque corresponding to a braking operation is output to each of the wheels.

For example, the steering device 220 includes a steering ECU and an electric motor. For example, the electric motor causes a force to act on a rack-and-pinion mechanism to change the direction of steered wheels. The steering ECU drives the electric motor in accordance with the information input from the lane keeping controller 150 or the lane change controller 160, or the information input from the driving operation piece 80 to change the direction of the steered wheels.

### Speed Adjustment Control

When executing driving assistance control and traveling on a curved road, the driving assistance device 100 controls the speed of the host vehicle M in accordance with the steering wheel grip state of the driver. Driving assistance control is control in which the speed controller 140 controls the speed of the host vehicle M and the lane keeping controller 150 executes the lane keeping control in a state where the driver is monitoring the surroundings of the host vehicle M. For example, the driving assistance device 100 causes the host vehicle M to travel at a lower speed when the driver is not gripping the steering wheel while the host vehicle M is traveling on a curved road than when the driver is gripping the steering wheel, and accelerates the host vehicle M or restrains the deceleration degree of the host vehicle M when it is determined that the driver has gripped the steering wheel in the case where the driver is not gripping the steering wheel and the host vehicle M is caused to travel on a curved road at a low speed. For example, traveling on a curved road may be the time when traveling on a road (lane) which curves in a curved road and may include, in addition to that described above, the time when the host vehicle M starts to decelerate to enter a curved road.

For example, the driving assistance device 100 causes the host vehicle M to travel according to a first speed plan when the driver is gripping the steering wheel while the host vehicle M is traveling on a curved road and causes the host vehicle M to travel according to a second speed plan when the driver is not gripping the steering wheel while the host vehicle M is traveling on a curved road. The driving assistance device 100 switches from the second speed plan to the first speed plan and causes the host vehicle M to travel on the basis of the first speed plan when it is determined that the driver has gripped the steering wheel in the case where the driver is not gripping the steering wheel and the host vehicle M is caused to travel according to the second speed plan. The driving assistance device 100 decelerates or accelerates the host vehicle M to cause the speed of the host vehicle M to match the speed prescribed in the first speed plan when the driver is gripping the steering wheel in the case where the speed of the host vehicle M is controlled on the basis of the second speed plan. The first speed plan and the second speed plan are information indicating transition of the speed of the host vehicle M when traveling on a curved road, and the second speed plan is a plan in which the host vehicle M is caused to travel at a speed lower than the speed according to the first speed plan. Details of the first speed plan and the second speed plan will be described below. Hereinafter, details of the speed adjustment control will be described below.

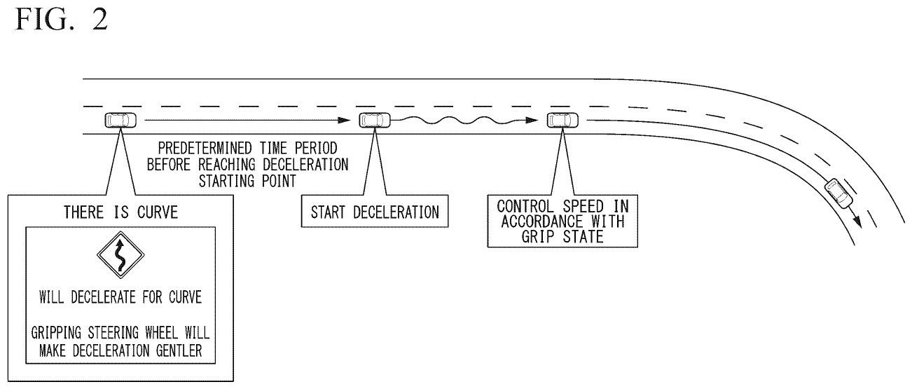

FIG. 2 is an explanatory view of speed adjustment control. The driving assistance device 100 provides first information to the driver via the HMI 30 before reaching a curved road. For example, the first information is that the road ahead is a curved road and the deceleration of the host vehicle M becomes gentler when traveling on a curved road if the steering wheel is gripped. When the host vehicle M reaches a location where it starts to decelerate, the driving assistance device 100 decelerates the host vehicle M.

The deceleration degree and the speed of the host vehicle M described above are determined on the basis of the steering wheel grip state of the driver. For example, when the driver is gripping the steering wheel (in the case of the hands-on state), the driving assistance device 100 decelerates the host vehicle M at the first deceleration degree. For example, when the driver is not gripping the steering wheel (in the case of the hands-off state), the driving assistance device 100 decelerates the host vehicle M at a second deceleration degree. The second deceleration degree is a deceleration degree larger than a first deceleration degree. The host vehicle M causes the host vehicle M to travel at a higher speed in the case of the hands-on state than in the case of the hands-off state.

In other words, the driving assistance device 100 determines a target speed in accordance with the steering wheel grip state. For example, the target speed in the case of the hands-on state is set to be higher than the target speed in the case of the hands-off state.

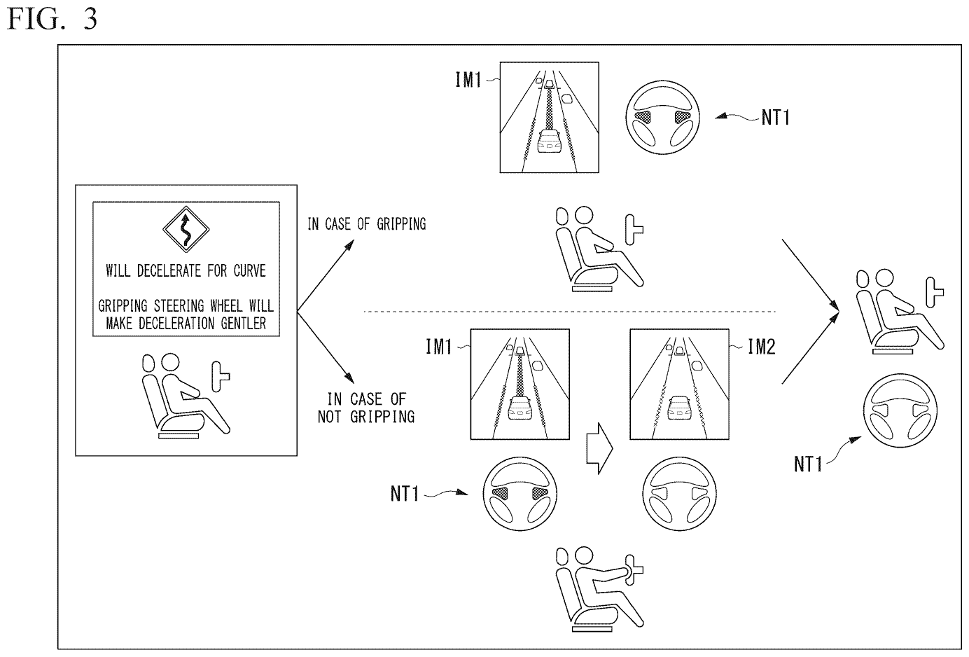

FIG. 3 is an explanatory view of a state of a driver and information provided via the HMI 30. For example, when the driver is not gripping the steering wheel in response to the first information, a first image IM1 is displayed, and a first notification is output. The first image IM1 is information indicating that the hands-off lane keeping control is being executed. A first notification NT1 is a notification recommending the hands-on state by causing a light emitter provided in the steering wheel to emit light in a first form.

For example, when the driver is gripping the steering wheel in response to the first information, a second image IM2 is displayed instead of the first image IM1, and an output of the first notification NT1 stops. The second image IM2 is information indicating that the hands-on lane keeping control is being executed due to a grip on the steering wheel. In addition, the driving assistance device 100 provides second information to the driver via the HMI 30 and notifies the driver only that he or she should decelerate for a curve. The second information is information indicating that the host vehicle M decelerates in order to travel on a curved road. Thereafter, when the host vehicle M reaches the end point or a spot near the end of the curved road, driving assistance control (hands-off lane keeping control) is continued or resumed.

### Relationship Between Operation and Control When Traveling on Curved Road

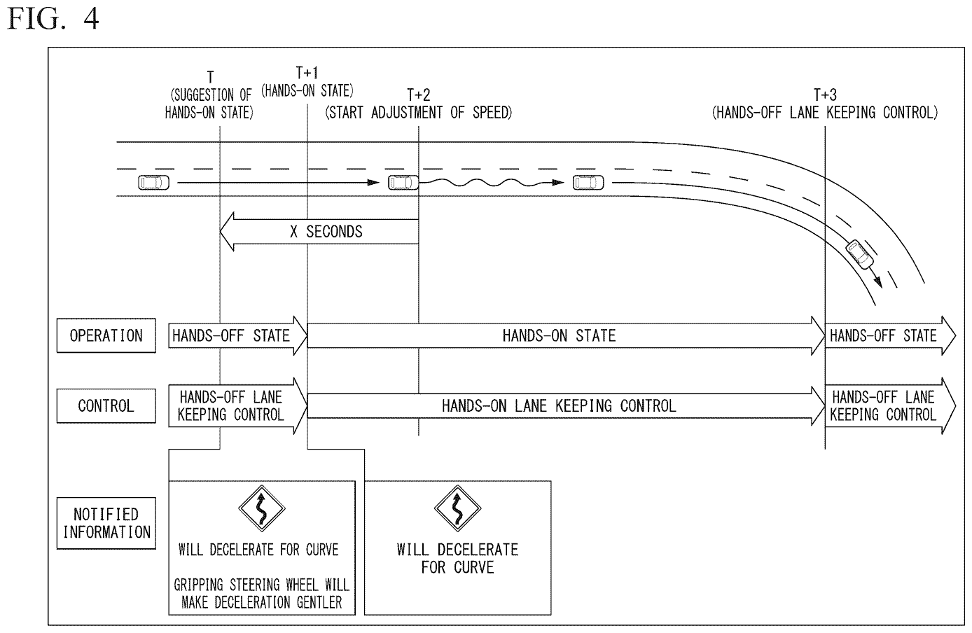

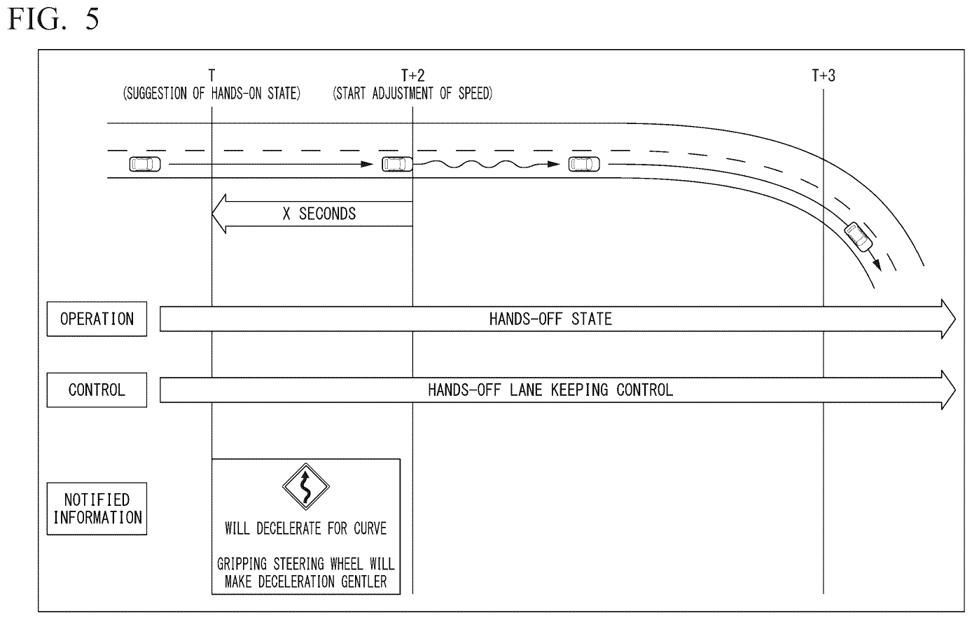

With reference to FIGS. 4 and 5, control in the case of the hands-on state (FIG. 4) and control in the case of the hands-off state (FIG. 5) when traveling on a curved road will be described.

FIG. 4 is an explanatory view of the speed adjustment control (part 1). A time T is a time when the driving assistance device 100 suggests the hands-on state (a time when the first information is provided). For example, the time T is a time before predetermined seconds (for example, five seconds, six seconds, seven seconds, or the like) from a time T+2 which will be described below. The time T may be a time before a predetermined distance from the time T+2.

When the driver is in the hands-on state at a time T+1, the second information is provided to the driver, and the driving assistance device 100 executes the hands-on lane keeping control instead of the hands-off lane keeping control. At the time T+2, the driving assistance device 100 starts to adjust the speed of the host vehicle M in order to cause the host vehicle M to travel on a curved road. For example, the time T+2 is a time when deceleration starts. The time T+2 is a timing when the host vehicle M reaches the entrance of a curved road or is within a predetermined distance or the like before the entrance. For example, the entrance of a curve is a location where a road (lane) starts to curve, or a location where a road curves by a threshold or greater. The time T+2 is a time corresponding to the location determined on the basis of the shape (curvature) of a curved road, the speed of the host vehicle M, surrounding circumstances, and the like.

From the time T+2 to a time T+3, the driving assistance device 100 controls the speed on the basis of the first speed plan. The first speed plan shows transition of the speed in the future which will be employed when the steering wheel is gripped. For example, the first speed plan is a plan in which the largest load applied to the occupant becomes smaller than a first degree when traveling on a curved road. For example, the load is an acceleration degree. The load may be an acceleration degree in a lateral direction with respect to the occupant. For example, the first degree is approximately 0.2 G to 0.3 G (for example, 0.25 G).

At the time T+3, the driving assistance device 100 executes the hands-off lane keeping control instead of the hands-on lane keeping control. The time T+3 is a time when the host vehicle M reaches the exit or a spot near the exit of a curved road. For example, the exit of a curve is a location where a road (lane) becomes straight, a location where the curvature of a road becomes smaller than a threshold, a location set in advance in the map information, or the like. After the time T+3, the hands-off lane keeping control is executed regardless of whether the driver is in the hands-on state or the hands-off state.

FIG. 5 is an explanatory view of the speed adjustment control (part 2).

Description will focus on points different from those in the description of FIG. 4. After the time T, in the case of not being in the hands-on state, the driving assistance device 100 continues to execute the hands-off lane keeping control. From the time T+2 to the time T+3, the driving assistance device 100 controls the speed on the basis of the second speed plan. The second speed plan shows transition of the speed in the future which will be employed when the steering wheel is not gripped. For example, the second speed plan is a plan in which the largest load applied to the occupant becomes smaller than a second degree when traveling on a curved road. For example, the second degree is approximately 0.1 G to 0.2 G (for example, 0.15 G). As in FIG. 5, when the hands-off lane keeping control is continued, the information notified at the time T continues to be displayed even after the time T+2.

### Flowchart (Part 1)

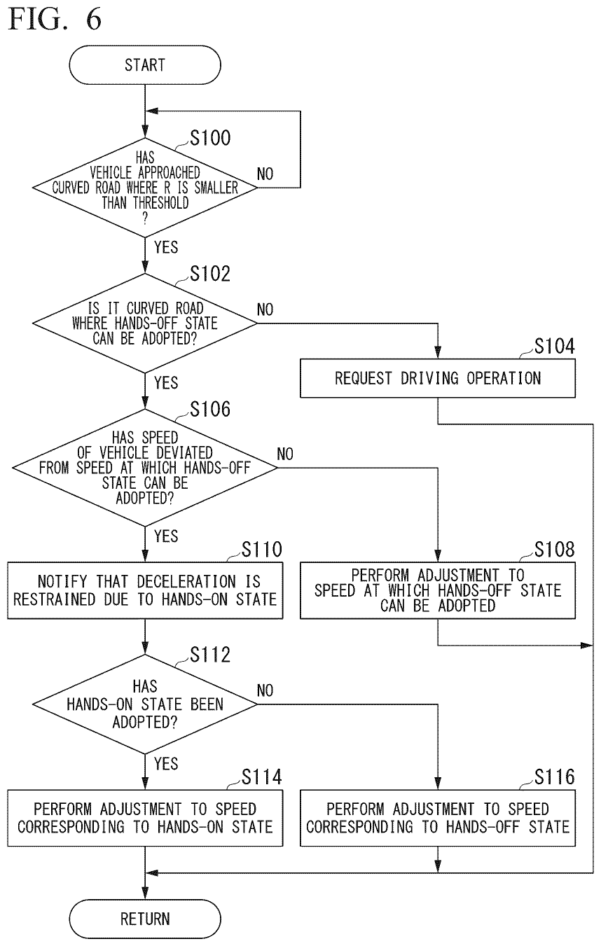

FIG. 6 is a flowchart showing an example of a flow of processing executed by the driving assistance device 100 (part 1). First, the curve determiner 130 determines whether or not the host vehicle M has approached a curved road where the R (radius of the circle) of the curve is smaller than a threshold on the basis of the location of the host vehicle M and the map information (Step S100). Approaching denotes being located within a predetermined distance or reaching a curved road after predetermined seconds. For example, the R being smaller than a threshold denotes that the R is approximately 200 to 400. For example, the R being smaller than a threshold denotes that the R is 300.

When approaching a curved road where the R of the curve is smaller than a threshold, the curve determiner 130 determines whether or not the approaching curved road is a curved road where the hands-off state can be adopted (Step S102). When the approaching curved road is not a curved road where the hands-off state can be adopted, the driving assistance device 100 requests the driver via the HMI 30 to perform a driving operation (S104). When this request is notified, the host vehicle M travels on the curved road by an operation of the driver.

The information indicating whether a curved road where the hands-off state can be adopted may be stored in the map information or may be determined by the driving assistance device 100 on the basis of recognition results of the object recognition device 16. A curved road where the hands-off state can be adopted denotes a curved road where it is difficult to identify a traveling path along which the host vehicle M will travel because it is difficult to identify the location of the host vehicle M or it is difficult to recognize the road, the lane, or surrounding circumstances on the basis of images captured by the camera 10. When the R of the curved road is smaller than a threshold which is smaller than the threshold (in the case of a sharp curve), it may be determined that the curved road is not a curved road where the hands-off state can be adopted.

When the approaching curved road is a curved road where the hands-off state can be adopted, the driving assistance device 100 determines whether or not the speed of the host vehicle M has deviated from the traveling speed on the curved road in the hands-off state by a predetermined speed or greater (S106). When the speed has not deviated by a predetermined speed or greater, the driving assistance device 100 adjusts the speed of the host vehicle M to a speed in the case of traveling on a curved road in the hands-off state on the basis of the timing when the speed starts to be adjusted (S108). When the speed has not deviated by a predetermined speed or greater as described above, the speed is already close to the traveling speed on the curved road in the hands-off state (close to the speed according to the second speed plan). Since there is no deviation from the feeling of the occupant even if the host vehicle M travels according to the second speed plan in the hands-off state, the speed of the host vehicle M is controlled as described above. For example, when a traffic jam occurs or the speed of a preceding vehicle is low, the speed of the host vehicle M may be close to the speed according to the second speed plan. In this case, even if control is executed on the basis of the second speed plan, the occupant may not feel uncomfortable, or the speed may match the feeling of the occupant.

When the speed has deviated by a predetermined speed or greater, the driving assistance device 100 notifies the driver of the first information indicating that deceleration is restrained due to the hands-on state (S110). Next, the driving assistance device 100 determines whether or not the hands-on state has been adopted (S112). When the hands-on state has been adopted, the driving assistance device 100 adjusts the speed of the host vehicle M to a speed corresponding to the hands-on state (S114). For example, the driving assistance device 100 controls the speed of the host vehicle M on the basis of the first speed plan. When the hands-on state has not been adopted, the driving assistance device 100 adjusts the speed of the host vehicle M to a speed corresponding to the hands-off state (S116). For example, the driving assistance device 100 controls the speed of the host vehicle M on the basis of the second speed plan.

As described above, the driving assistance device 100 can control the speed of the host vehicle M to a speed that suits the feeling of the occupant in accordance with the steering wheel grip state of the driver.

When the host vehicle M travels on a curved road where the R of the curve is equal to or greater than a threshold (gently curved road), the driving assistance device 100 may execute the hands-off lane keeping control by controlling the host vehicle M at a speed that suits the feeling of the driver (without excessive deceleration). In this case, the speed of the host vehicle M may be controlled according to the same speed plan in both the hands-on state and the hands-off state.

### Flowchart (Part 2)

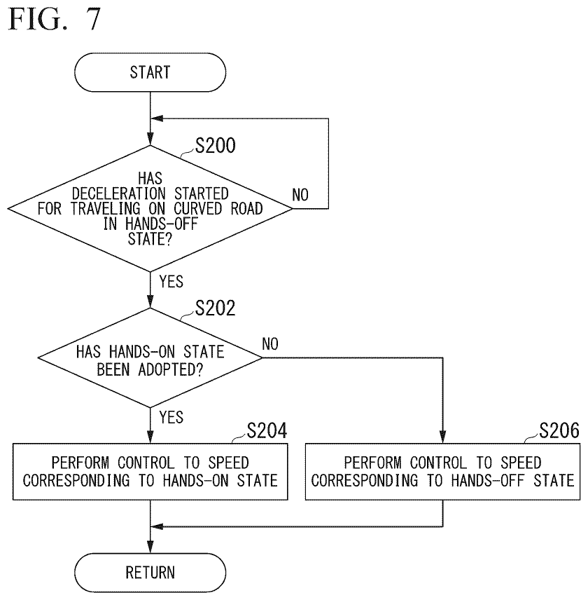

FIG. 7 is a flowchart showing an example of a flow of processing executed by the driving assistance device 100 (part 2). This processing is processing related to speed control in the case of the hands-on state when the speed is adjusted on the basis of the second speed plan in the hands-off state.

First, when the driving assistance device 100 has started to adjust the speed for traveling on a curved road in the hands-off state (Step S200), it is determined whether or not the hands-on state has been adopted (S202). When the hands-on state has been adopted during a predetermined period, the driving assistance device 100 controls the speed of the host vehicle M to a speed corresponding to the hands-on state (a speed based on the first speed plan) (Step S204). When the hands-on state has not been adopted, the driving assistance device 100 controls the speed of the host vehicle M to a speed corresponding to the hands-off state (a speed based on the second speed plan) (Step S206). Accordingly, the processing of one routine of this flowchart ends.

### Control in Case of Hands-On State During Speed Adjustment (1)

The driving assistance device 100 decelerates the host vehicle M to a first speed according to the first speed plan in the case where the driver is gripping the steering wheel while the host vehicle M is traveling on a curved road, decelerates the host vehicle M to a second speed of the second speed plan in the case where the driver is not gripping the steering wheel while the host vehicle M is traveling on a curved road and restrains the degree of deceleration of the host vehicle M when it is determined that the driver has gripped the steering wheel in the case where the driver is not gripping the steering wheel and the host vehicle M is decelerated to be closer to the second speed while the host vehicle M is traveling on a curved road.

The driving assistance device 100 decelerates the host vehicle M to the first speed instead of decelerating it to the second speed in the case where the driver is not gripping the steering wheel and the host vehicle M is decelerated to be closer to the second speed while the host vehicle M is traveling on a curved road and in the case where the driver is gripping the steering wheel and the speed of the host vehicle M exceeds the first speed.

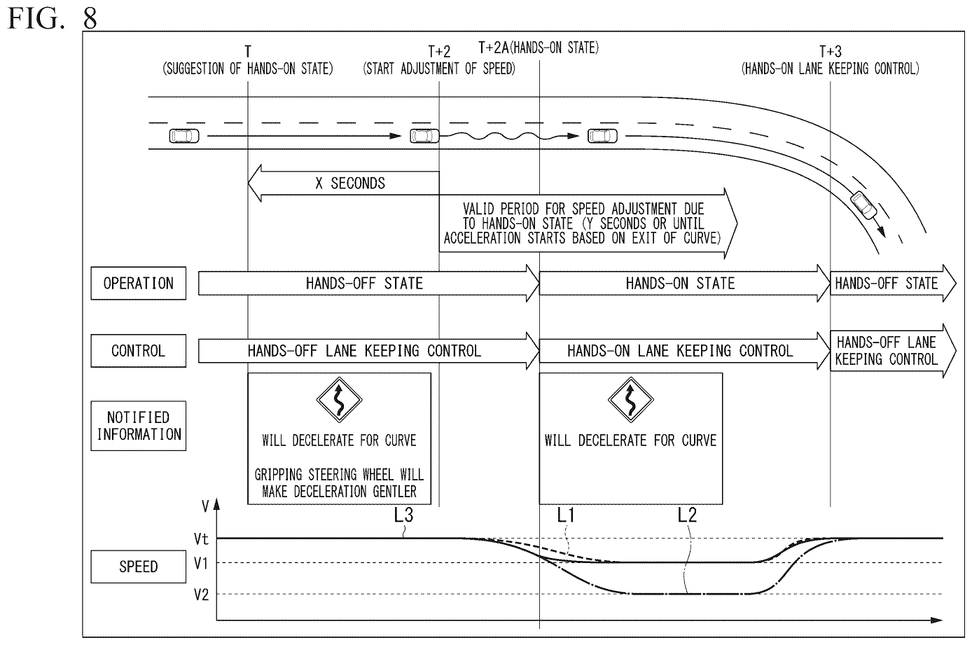

FIG. 8 is an explanatory view of control in a case of the hands-on state during speed adjustment (part 1). Description will focus on points different from the details in FIGS. 4 and 5. A control line L1 indicates transition of the speed according to the first speed plan (change in target speed Vt) when the host vehicle M travels on a curved road in the hands-on state. The first speed plan is a plan in which the host vehicle M is accelerated to the target speed Vt when the host vehicle M starts deceleration at a deceleration starting location (a location corresponding to the time T+2), is decelerated to a first speed V1, and reaches an acceleration starting location (second reference location) after traveling at the first speed V1 for a predetermined time period. For example, the target speed Vt is the target speed Vt set in the ACC. For example, the acceleration starting location is a location before the exit or a spot near the exit of a curved road within a predetermined distance at the time T+3. For example, the acceleration starting location is a location where the host vehicle M accelerates to be closer to the target speed Vt.

A control line L2 indicates transition of the speed according to the second speed plan (change in the target speed Vt) when the host vehicle M travels on a curved road in the hands-off state. The second speed plan is a plan in which the host vehicle M is accelerated to the target speed Vt when the host vehicle M starts deceleration at the deceleration starting location (a location corresponding to the time T+2), is decelerated to a second speed V2 and reaches the acceleration starting location (second reference location) after traveling at the second speed V2 for a predetermined time period. The second speed V2 is a speed lower than the first speed V1. For example, the target speed Vt is the target speed Vt set in the ACC. For example, the acceleration starting location is a location before the exit or a spot near the exit of a curved road within a predetermined distance at the time T+3. For example, the acceleration starting location is a location where the host vehicle M accelerates to be closer to the target speed Vt.

The deceleration starting location according to the first speed plan and the deceleration starting location according to the second speed plan may be the same location or may be different locations. The acceleration starting location according to the first speed plan and the acceleration starting location according to the second speed plan may be the same location or may be different locations.

A control line L3 indicates change in the speed of the host vehicle M of the example in FIG. 8. It is assumed that the hands-off state is adopted during a period from the time T+1 to the time T+2 and after the time T+2 and the hands-on state is adopted at a time T+2A after a predetermined time period from the time T+2. The speed of the host vehicle M is controlled to match the control line L2 until the time T+2A. At the time T+2A, the speed of the host vehicle M is a speed higher than the first speed V1 and lower than the speed of the control line L1. At the time T+2A, the driving assistance device 100 restrains the deceleration degree of the host vehicle M to control the speed of the host vehicle M such that the speed of the host vehicle M matches the control line L1. In this case, the driving assistance device 100 restrains the deceleration degree of the host vehicle M so as to smoothly match the speed of the control line L1 without steeply changing the speed of the host vehicle M. For example, the foregoing term “smoothly” denotes that the slope of change in speed (or deceleration degree) is equal to or smaller than a threshold.

For example, the driving assistance device 100 restrains the deceleration degree of the speed of the host vehicle M to control the speed of the host vehicle M such that the speed of the host vehicle M matches the speed of the control line L1 after a predetermined time period from the time T+2A. When the speed of the host vehicle M matches the speed of the control line L1, the driving assistance device 100 controls the speed of the host vehicle M on the basis of the speed of the control line L1.

As shown in FIG. 8, a valid period allowing switching from the second speed plan to the first speed plan may be set. For example, the driving assistance device 100 may switch from the second speed plan to the first speed plan when the driver is in the hands-on state within the valid period and maintain the second speed plan when the driver is in the hands-on state after the valid period. For example, the valid period may be a predetermined time period from the time T+2 or may be a period until the time when acceleration starts from the second speed.

As described above, when the driver is in the hands-on state, the driving assistance device 100 can restrain the deceleration degree to cause the host vehicle M to travel at a speed that suits the feeling of the driver.

### Control in Case of Hands-On State During Speed Adjustment (2)

The driving assistance device 100 decelerates the host vehicle M to the first speed V1 according to the first speed plan in the case where the driver is gripping the steering wheel while the host vehicle M is traveling on a curved road, decelerates the host vehicle M to the second speed V2 of the second speed plan in the case where the driver is not gripping the steering wheel while the host vehicle M is traveling on a curved road and accelerates the host vehicle M when it is determined that the driver has gripped the steering wheel in the case where the driver is not gripping the steering wheel and the host vehicle M is decelerated to be closer to the second speed while the host vehicle M is traveling on a curved road.

The driving assistance device 100 accelerates the host vehicle M to the first speed V1 in the case where the driver is not gripping the steering wheel and the host vehicle M is decelerated to be closer to the second speed V2 while the host vehicle M is traveling on a curved road and in the case where the driver is gripping the steering wheel and the speed of the host vehicle M is lower than the first speed.

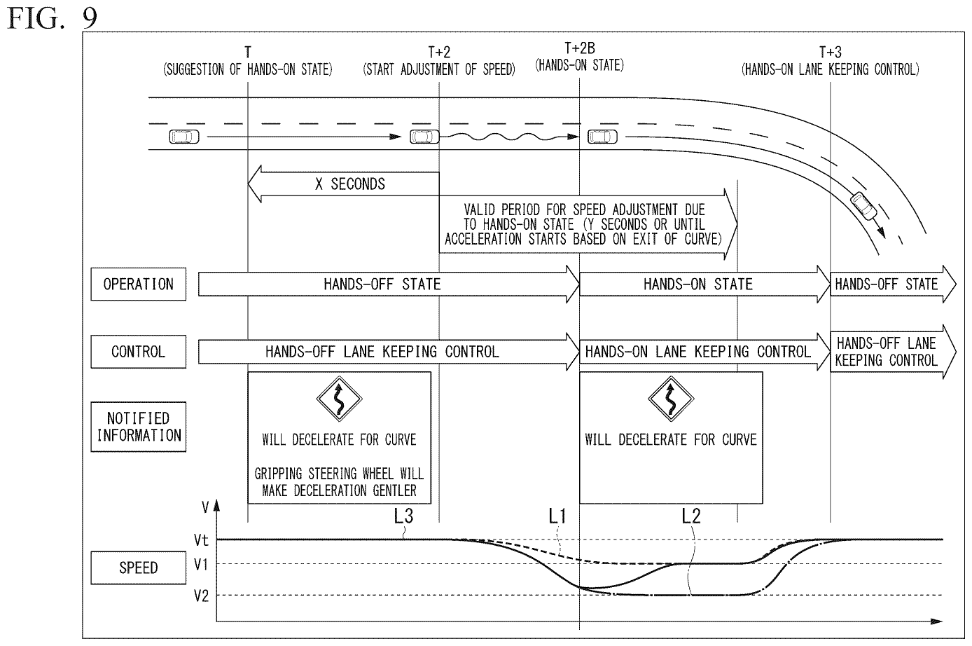

FIG. 9 is an explanatory view of control in a case of the hands-on state during speed adjustment (part 2). It is assumed that the hands-off state is adopted during the period from the time T+1 to the time T+2 and after the time T+2 and the hands-on state is adopted at a time T+2B (a time later than the time T+2A) after a predetermined time period from the time T+2. The speed of the host vehicle M is controlled to match the control line L2 until the time T+2B. At the time T+2B, the speed of the host vehicle M is a speed higher than the second speed V2 and lower than the first speed V1 of the control line L1.

At the time T+2B, the driving assistance device 100 controls the speed of the host vehicle M such that the speed of the host vehicle M matches the control line L1. In this case, the driving assistance device 100 accelerates the host vehicle M such that the speed of the host vehicle M matches the speed of the control line L1. Acceleration may be constrained by a slope of change in speed due to acceleration being equal to or smaller than a threshold, or an acceleration degree due to acceleration being equal to or smaller than a threshold. Acceleration may be constrained by a load applied to the occupant (for example, an acceleration degree) being smaller than a threshold.

For example, the driving assistance device 100 accelerates the host vehicle M to control the speed of the host vehicle M such that the speed of the host vehicle M matches the first speed V1 of the control line L1 after a predetermined time period from the time T+2B. When the speed of the host vehicle M matches the first speed V1 of the control line L1, the driving assistance device 100 controls the speed of the host vehicle M on the basis of the first speed V1 of the control line L1.

As described above, when the driver is in the hands-on state, the driving assistance device 100 can accelerate the host vehicle M to cause the host vehicle M to travel at a speed that suits the feeling of the driver.

### Control in Case of Hands-On State During Speed Adjustment (3)

The driving assistance device 100 causes the host vehicle M to travel at the first speed V1 in the case where the driver is gripping the steering wheel while the host vehicle M is traveling on a curved road, causes the host vehicle M to travel at the second speed V2 lower than the first speed V1 in the case where the driver is not gripping the steering wheel while the host vehicle M is traveling on a curved road and accelerates the host vehicle M to the first speed V1 when it is determined that the driver has changed from a state of not gripping the steering wheel to a state where the driver is gripping the steering wheel while the host vehicle M is traveling at the second speed V2.

In FIG. 9 described above, an example in which the host vehicle M is accelerated to the first speed V1 if the hands-on state is adopted when the speed of the host vehicle M is lower than the first speed V1 and equal to or higher than the second speed V2 has been described. For example, even when the hands-on state is adopted after the host vehicle M has been decelerated to the second speed V1, the driving assistance device 100 accelerates the host vehicle M to the first speed V1. The driving assistance device 100 accelerates the host vehicle M to cause the speed of the host vehicle M to match the speed prescribed in the first speed plan when the driver is gripping the steering wheel and the speed of the host vehicle M is lower than the speed prescribed in the first speed plan in the case where the host vehicle M is caused to travel on the basis of the second speed plan.

As described above, when the driver is in the hands-on state while the host vehicle M is traveling at the second speed V2, the driving assistance device 100 can accelerate the host vehicle M to cause the host vehicle M to travel at a speed that suits the feeling of the driver.

### Control in Case of Hands-On State During Speed Adjustment (4)

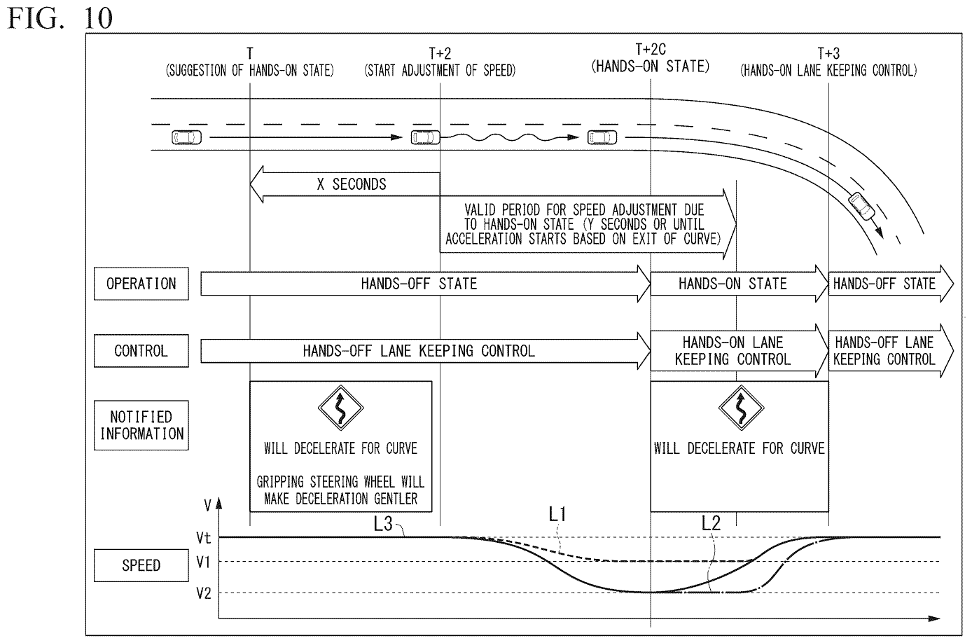

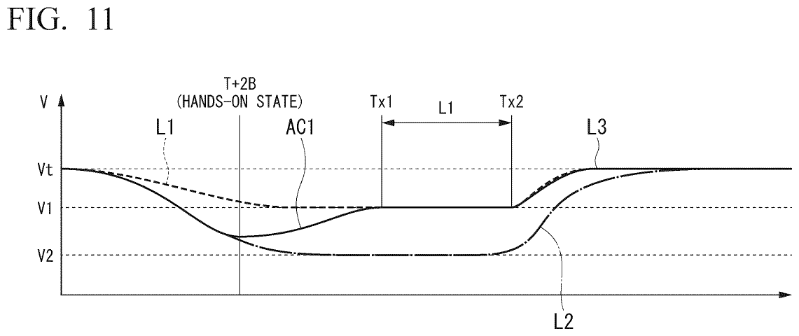

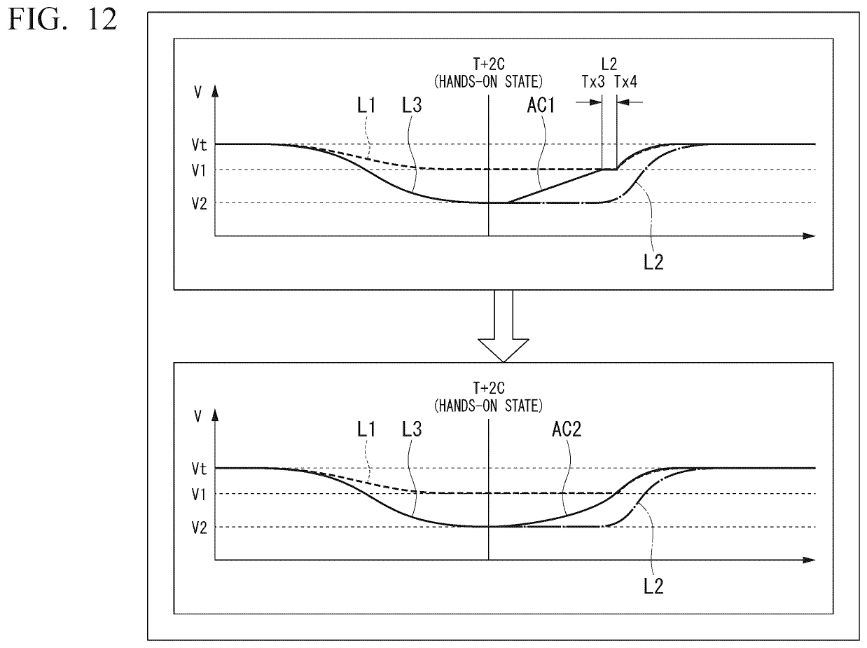

When conditions which will be described below are satisfied, the driving assistance device 100 may perform control such that the speed of the host vehicle M matches the target speed Vt instead of the first speed V1. For example, the driving assistance device 100 causes the speed of the host vehicle M to follow the speed prescribed in the first speed plan at the time of (i) and causes the speed of the host vehicle M to follow a speed prescribed in a speed plan different from the first speed plan at the time of (ii) when the driver is gripping the steering wheel and the speed of the host vehicle M is lower than the speed prescribed in the first speed plan in the case where the host vehicle M is caused to travel on the basis of the second speed plan. The first speed plan is a plan in which the speed of the host vehicle M is decelerated to the first speed V1, the host vehicle M is caused to travel at the first speed V1 during a first time period, and then the host vehicle M is accelerated. A different speed plan is a plan in which the speed of the host vehicle M is caused to smoothly match the target speed Vt.
(i) indicates that a time period from a first time point when the speed of the host vehicle M has reached the first speed V1 to the end point (for example, the second reference location where the host vehicle M is accelerated) of the first time period is equal to or longer than a threshold in the case where it is assumed that the speed of the host vehicle M is caused to match the first speed V1 at a predetermined acceleration.
(ii) indicates that the time period from the first time point when the speed of the host vehicle M has reached the first speed V1 to the end point of the first time period is shorter than the threshold in the case where it is assumed that the speed of the host vehicle M is caused to match the first speed V1 at a predetermined acceleration. Control of causing the speed of the host vehicle M to match the target speed Vt will be described with reference to FIG. 10, and conditions therefor will be described with reference to FIGS. 11 and 12.

FIG. 10 is an explanatory view of control in a case of the hands-on state during speed adjustment (part 3). It is assumed that the hands-off state is adopted during the period from the time T+1 to the time T+2 and after the time T+2 and the hands-on state is adopted at a time T+2C (a time later than the time T+2B) after a predetermined time period from the time T+2. The speed of the host vehicle M is controlled to match the speed of the control line L2 until the time T+2C. At the time T+2C, the speed of the host vehicle M is the second speed V2. At the time T+2C, the driving assistance device 100 accelerates the host vehicle M such that the speed of the host vehicle M matches the target speed Vt higher than the first speed V1 instead of matching the speed of the control line L1.

For example, the driving assistance device 100 controls the speed of the host vehicle M so as to smoothly shift to the target speed Vt from the speed at the time T+2C. For example, the foregoing term “smoothly” denotes that the slope of change in speed is equal to or smaller than a threshold, the acceleration degree corresponding to change in speed is equal to or smaller than a threshold, or the like.

For example, the driving assistance device 100 accelerates the host vehicle M to control the speed of the host vehicle M such that the speed of the host vehicle M matches the target speed Vt after a predetermined time period from the time T+2C. When the speed of the host vehicle M matches the target speed Vt, the driving assistance device 100 controls the speed of the host vehicle M on the basis of the target speed Vt.

### Conditions

The conditions include that the hands-on state is adopted after reaching a reference location set on the basis of the exit of a curve or a spot near the exit of a curve. The driving assistance device 100 controls the speed of the host vehicle M such that the speed of the host vehicle M is caused to be closer to the target speed Vt when the conditions are satisfied, and controls the speed of the host vehicle M such that the speed of the host vehicle M is caused to be closer to the first speed V1 when the conditions are not satisfied.

FIG. 11 is a view showing an example of being controlled to the first speed. When the hands-on state is adopted at the time T+2B in FIG. 9 described above, the driving assistance device 100 derives a first time Tx1 when the speed of the host vehicle M reaches the first speed V1 in the case where it is assumed that the host vehicle M is accelerated at an acceleration degree satisfying the constraint (for example, a first acceleration degree AC1). The driving assistance device 100 controls the speed of the host vehicle M to the first speed V1 to cause the host vehicle M to travel at the first speed V1 until the second time in the case where a time period L1 from the first time Tx1 to a second time Tx2 when acceleration starts toward the target speed Vt (for example, a time when reaching the second reference location which is the acceleration starting location where the host vehicle M is accelerated) is equal to or longer than a threshold.

FIG. 12 is a view showing an example of being controlled to the target speed. When the hands-on state is adopted at the time T+2C in FIG. 10 described above, the driving assistance device 100 derives a third time Tx3 when the speed of the host vehicle M reaches the first speed V1 in the case where it is assumed that the host vehicle M is accelerated at an acceleration degree satisfying the constraint (for example, the first acceleration degree AC1). In the case where a time period L2 from the third time Tx3 to a fourth time Tx4 when acceleration starts toward the target speed Vt (for example, a time when reaching the second reference location which is the acceleration starting location where the host vehicle M is accelerated) is shorter than the threshold (refer to the upper diagram in FIG. 12), the driving assistance device 100 controls the speed of the host vehicle M to the target speed Vt instead of the first speed V1 to cause the host vehicle M to travel (refer to the lower diagram in FIG. 12). In this case, the driving assistance device 100 accelerates the host vehicle M at the first acceleration degree AC1 which is gentler than a second acceleration degree AC2.

As described above, the driving assistance device 100 accelerates the host vehicle M to the first speed V1 at the first acceleration degree AC1 when the driver is gripping the steering wheel while the host vehicle M is traveling at the speed according to the second speed plan (for example, the second speed V2) and before the host vehicle M reaches a first reference location set on the basis of the exit of a curve or a spot near the exit of a curve, and accelerates the host vehicle M to the first speed V1 at the second acceleration degree AC2 which is gentler than the first acceleration degree AC1 when the driver is gripping the steering wheel while the host vehicle M is traveling at the second speed V2 and after the host vehicle M has reached the first reference location. The driving assistance device 100 accelerates the host vehicle M to the first speed V1 at the first acceleration degree AC1 when the host vehicle M can be caused to travel at the first speed V1 for a set period or longer, and accelerates the host vehicle M to the second speed V2 at the second acceleration degree AC2 when the host vehicle M cannot be caused to travel at the first speed V1 for a set period or longer. In other words, the driving assistance device 100 does not allow traveling at the first speed V1 for shorter than a set period. The first reference location is a location where the speed reaches the first speed V1 and a time period of traveling at the first speed V1 is equal to or longer than a set period when the host vehicle M is accelerated at a predetermined acceleration degree (details will be described below).

For example, if the host vehicle M is accelerated to the first speed V1, travels at the first speed V1 for a time period shorter than a threshold, and is instantly accelerated toward the target speed Vt, the occupant may feel uncomfortable. In the present embodiment, the driving assistance device 100 restrains uncomfortable feeling of the occupant by controlling the host vehicle M such that the time period during which the host vehicle M travels at the second speed V2 becomes equal to or longer than a threshold or performing acceleration based on the target speed Vt when the time period during which the host vehicle M travels at the second speed V2 is shorter than a threshold. The driving assistance device 100 can improve the comfort of the occupant.

For example, the first reference location described above may be a location prescribed in the map information and set in advance, or may be a location set on the basis of the exit or the location near the exit a curved road set on the basis of recognition results of the object recognition device 16. For example, the first reference location may be derived as described below.

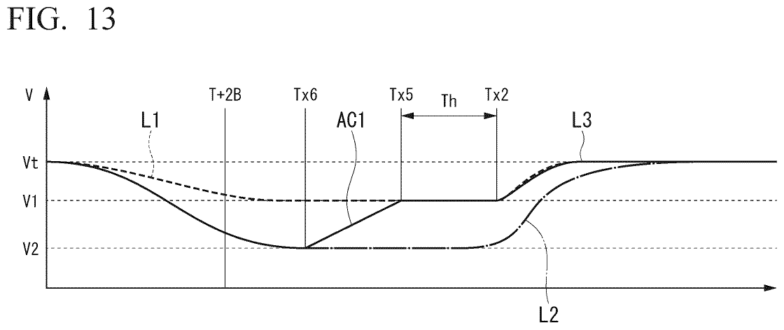

FIG. 13 is an explanatory view of the first reference location. The first reference location is set by the following idea. As shown in FIG. 13, the location corresponding to the acceleration starting location (second reference location) where acceleration starts toward the target speed Vt is set in advance. If the end point of a threshold Th for the time period during which the host vehicle M reaches the first speed V1 from the speed according to the second speed plan and then travels at the first speed V1 is set to a time Tx2, a time Tx5 which is the starting point of the threshold Th is derived. A time Tx6 satisfying conditions that the host vehicle M is accelerated at the first acceleration degree AC and the host vehicle M reaches the first speed V1 at the time Tx5 is obtained. The location corresponding to this time Tx6 is the first reference location.

As described above the driving assistance device 100 accelerates the host vehicle M to the first speed V1 at the first acceleration degree AC1 in the case where the time period from the first time to the second time is equal to or longer than a threshold when the driver is gripping the steering wheel while the host vehicle is traveling at the second speed V2, and accelerates the host vehicle M at the second acceleration degree AC2 in the case where the time period from the first time to the second time is shorter than the threshold when the driver is gripping the steering wheel while the host vehicle M is traveling at the second speed V2. The first time is a time when the speed of the host vehicle M reaches the first speed V1 in the case where it is assumed that the host vehicle M is accelerated at the first acceleration degree AC1, and the second time is a time when the host vehicle M reaches the second reference location in the case where the host vehicle M has traveled at the first speed V1 from the first time.

In the foregoing example, setting an acceleration degree when the hands-on state is adopted in the case where the host vehicle M is traveling mainly at the second speed V2 has been described. In addition to (or instead of) this, similar processing may be executed even when the host vehicle M is decelerating. The driving assistance device 100 accelerates the host vehicle M to the first speed V1 at the first acceleration degree AC1 when the driver is gripping the steering wheel while the host vehicle M is decelerated to be closer to the second speed V2 and before the host vehicle M reaches the first reference location set on the basis of the exit of a curve or a spot near the exit of a curve, and accelerates the host vehicle M to the first speed V1 at the second acceleration degree AC2 which is gentler than the first acceleration degree AC1 when the driver is gripping the steering wheel while the host vehicle M is decelerated to be closer to the second speed V2 and after the host vehicle M reaches the first reference location.

The driving assistance device 100 accelerates the host vehicle M to the first speed V1 at the first acceleration degree AC1 in the case where the time period from the first time to the second time is equal to or longer than a threshold when the host vehicle M is decelerated to be closer to the second speed V2 and the driver is gripping the steering wheel, and accelerates the host vehicle M at the second acceleration degree AC2 in the case where the time period from the first time to the second time is shorter than the threshold when the host vehicle M is decelerated to be closer to the second speed V2 and the driver is gripping the steering wheel.

### Flowchart (Part 3)

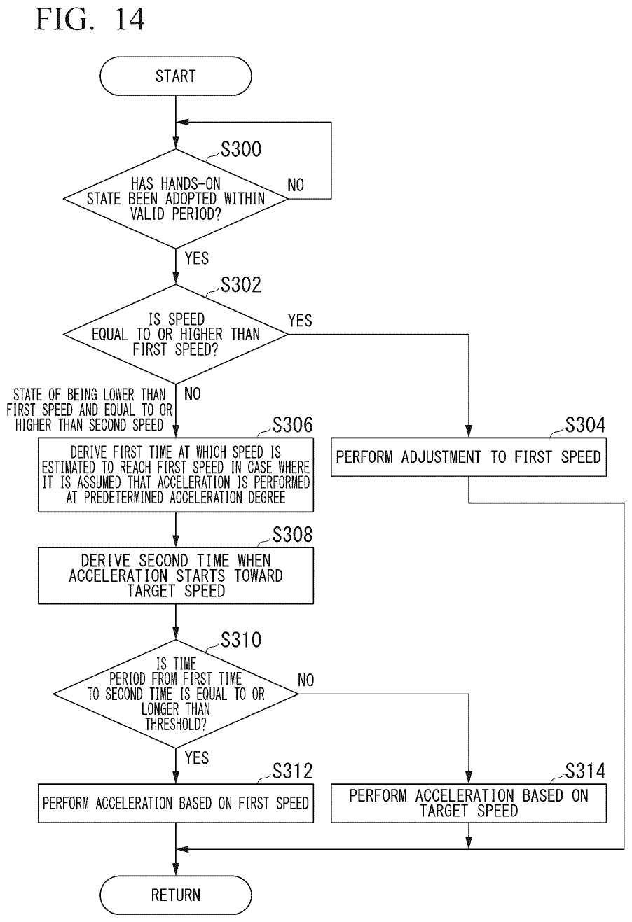

FIG. 14 is a flowchart showing an example of a flow of processing executed by the driving assistance device 100 (part 3). First, the driving assistance device 100 determines whether or not the hands-off state has changed to the hands-on state within a valid period (Step S300). When the hands-on state is adopted, the driving assistance device 100 determines whether or not the speed of the host vehicle M is equal to or higher than the first speed V1 (Step S302). When the speed of the host vehicle M is equal to or higher than the first speed V1, the driving assistance device 100 adjusts the speed of the host vehicle M to the first speed V1 (Step S304).

When the speed of the host vehicle M is not equal to or higher than the first speed V1 (lower than the first speed V1 and equal to or higher than the second speed V2), the driving assistance device 100 derives the first time at which the speed is estimated to reach the first speed V1 in the case where it is assumed that the host vehicle M is accelerated at a predetermined acceleration degree (an acceleration degree satisfying the constraint) (Step S306). Next, the driving assistance device 100 derives the second time when acceleration starts toward the target speed Vt (Step S308).

The driving assistance device 100 determines whether or not the time period from the first time to the second time is equal to or longer than a threshold (Step S310). When the time period from the first time to the second time is equal to or longer than the threshold, the driving assistance device 100 accelerates the host vehicle M to the first speed V1 at the first acceleration AC1 (Step S312). When the time period from the first time to the second time is shorter than the threshold, the driving assistance device 100 accelerates the host vehicle M based on the target speed Vt (Step S314). For example, the driving assistance device 100 accelerates the host vehicle M to the first speed V1 at the second acceleration AC2 and further accelerates the host vehicle M to the target speed Vt at a predetermined acceleration degree.

In the foregoing Step S310, it is determined whether or not the time period from the first time to the second time is equal to or longer than a threshold. However, instead of this, the driving assistance device 100 may acquire the first reference location and determine whether or not the host vehicle M has reached the first reference location.

As described above, the driving assistance device 100 can perform driving assistance that suits the feeling of the occupant, and the comfort of the occupant can be improved.

In the foregoing example, it has been described that driving assistance control is executed in a state where the driver is monitoring the surroundings of the host vehicle M, but it may be executed in a state of not monitoring the surroundings thereof.

In the foregoing example, an example in which the driving assistance device 100 controls the speed in accordance with the steering wheel grip state of the driver has been described. However, in addition thereto (alternatively), an automated driving control device (not shown) may execute similar processing. The automated driving control device controls the speed and steering of the host vehicle M without relying on an operation of the driver. The automated driving control device controls the speed in accordance with the steering wheel grip state of the driver when traveling on a curved road. For example, the automated driving control device restrains the deceleration degree to cause the speed of the host vehicle M to approach the first speed V1 and accelerates the host vehicle M to approach the first speed V1 when the driver is gripping the steering wheel. Accordingly, the automated driving control device can improve the comfort of the occupant by realizing automated driving that suits the feeling of the occupant in automated driving. The automated driving device is an example of “a vehicle control device”.

The embodiment described above can be expressed as follows.

A vehicle control device includes a storage medium storing computer-readable instructions, and a processor connected to the storage medium. The processor executes the computer-readable instructions to execute: processing of recognizing surrounding circumstances of a vehicle, processing of determining whether or not a driver of the vehicle is gripping a steering wheel of the vehicle, processing of controlling a speed of the vehicle and steering of the vehicle on the basis of the surrounding circumstances, processing of causing the vehicle to travel according to a first speed plan in a case where the driver is gripping the steering wheel and causing the vehicle to travel according to a second speed plan for causing the vehicle to travel at a speed lower than a speed according to the first speed plan in a case where the driver is not gripping the steering wheel while the vehicle is traveling on a curved road, in which the first speed plan and the second speed plan are information indicating transition of the speed of the vehicle when traveling on the curved road, and processing of switching the second speed plan to the first speed plan and causing the vehicle to travel on the basis of the first speed plan when it is determined that the driver has gripped the steering wheel in a case where the driver is not gripping the steering wheel and the vehicle is caused to travel on the curved road according to the second speed plan.

Hereinabove, forms for performing the present invention have been described using an embodiment. However, the present invention is not limited to such an embodiment at all, and various modifications and replacements can be added within a range not departing from the gist of the present invention.

### REFERENCE SIGNS LIST

10 Camera
16 Object recognition device
100 Driving assistance device
110 Recognizer
130 Curve determiner
140 Speed controller
150 Lane keeping controller

What is claim is:

1-13 (canceled)

14. A vehicle control device comprising:
a storage medium storing computer-readable instructions; and
at least one processor connected to the storage medium,
wherein the processor executes the computer-readable instructions to:
recognize surrounding circumstances of a vehicle;
determine whether or not a driver of the vehicle is gripping a steering wheel of the vehicle; and
control a speed of the vehicle and steering of the vehicle on the basis of the surrounding circumstances,
cause the vehicle to travel according to a first speed plan in a case where the driver is gripping the steering wheel and causes the vehicle to travel according to a second speed plan for causing the vehicle to travel at a speed lower than a speed according to the first speed plan in a case where the driver is not gripping the steering wheel while the vehicle is traveling on a curved road,
the first speed plan and the second speed plan are information indicating transition of the speed of the vehicle when traveling on the curved road, and
the second speed plan is switched to the first speed plan and the vehicle is caused to travel on the basis of the first speed plan when it is determined that the driver has gripped the steering wheel in a case where the driver is not gripping the steering wheel and the vehicle is caused to travel on the curved road according to the second speed plan.

15. The vehicle control device according to claim 14,
wherein the processor executes the computer-readable instructions to:
restrain a deceleration degree of the vehicle or accelerates the vehicle to cause the speed of the vehicle to match a speed prescribed in the first speed plan when the driver grips the steering wheel in a case where the speed of the vehicle is controlled on the basis of the second speed plan.

16. The vehicle control device according to claim 14,
wherein the processor executes the computer-readable instructions to:
cause the vehicle to travel at a first speed according to the first speed plan in a case where the driver is gripping the steering wheel while the vehicle is traveling on a curved road,
cause the vehicle to travel at a second speed according to the second speed plan lower than the first speed in a case where the driver is not gripping the steering wheel while the vehicle is traveling on a curved road, and
accelerate the vehicle to the first speed when it is determined that the driver has changed from a state of not gripping the steering wheel to a state where the driver is gripping the steering wheel while the vehicle is traveling at the second speed.

17. The vehicle control device according to claim 15,
wherein the processor executes the computer-readable instructions to:
accelerate the vehicle to a first speed according to the first speed plan at a first acceleration degree when the driver is gripping the steering wheel while the vehicle is traveling according to the second speed plan and before the vehicle reaches a first reference location set on the basis of an exit of a curve or a spot near the exit of a curve, and
accelerate the vehicle to the first speed at a second acceleration degree which is gentler than the first acceleration degree when the driver is gripping the steering wheel while the vehicle is traveling according to the second speed plan and after the vehicle has reached the first reference location.

18. The vehicle control device according to claim 17,
wherein the processor executes the computer-readable instructions to: cause the vehicle to travel according to the first speed plan in a case where the driver is gripping the steering wheel while the vehicle is traveling on a curved road and accelerates the vehicle in a case where the vehicle has reached a second reference location set on the basis of an exit of a curve or a spot near the exit of a curve,
accelerate the vehicle to the first speed at the first acceleration degree in a case where a time period from a first time to a second time is equal to or longer than a threshold when the driver is gripping the steering wheel while the vehicle is traveling according to the second speed plan, and
accelerate the vehicle at the second acceleration degree in a case where the time period from the first time to the second time is shorter than the threshold when the driver is gripping the steering wheel while the vehicle is traveling according to the second speed plan,
the first time is a time when the speed of the vehicle reaches the first speed in a case where it is assumed that the vehicle is accelerated at the first acceleration degree, and
the second time is a time when the vehicle reaches the second reference location in a case where the vehicle has traveled at the first speed from the first time.

19. The vehicle control device according to claim 14,
wherein the processor executes the computer-readable instructions to:
decelerate the vehicle to a first speed according to the first speed plan in a case where the driver is gripping the steering wheel while the vehicle is traveling on a curved road,
decelerate the vehicle to a second speed according to the second speed plan lower than the first speed in a case where the driver is not gripping the steering wheel while the vehicle is traveling on a curved road, and
accelerate the vehicle or restrains a degree of deceleration when it is determined that the driver has gripped the steering wheel in a case where the driver is not gripping the steering wheel and the vehicle is decelerated to be closer to the second speed while the vehicle is traveling on a curved road.

20. The vehicle control device according to claim 19,
wherein the processor executes the computer-readable instructions to:
in a case where the driver is not gripping the steering wheel and the vehicle is decelerated to be closer to the second speed while the vehicle is traveling on a curved road, decelerate the vehicle to the first speed instead of decelerating the vehicle to the second speed when the driver grips the steering wheel and the speed of the vehicle exceeds the first speed.

21. The vehicle control device according to claim 19,
wherein the processor executes the computer-readable instructions to:
in a case where the driver is not gripping the steering wheel and the vehicle is decelerated to be closer to the second speed while the vehicle is traveling on a curved road, accelerate the vehicle to the first speed when the driver grips the steering wheel and the speed of the vehicle is lower than the first speed.

22. The vehicle control device according to claim 21,
wherein the processor executes the computer-readable instructions to:
accelerate the vehicle to the first speed according to the first speed plan at a first acceleration degree when the driver is gripping the steering wheel while the vehicle is decelerated to be closer to the second speed according to the second speed plan and before the vehicle reaches a first reference location set on the basis of an exit of a curve or a spot near the exit of a curve, and
accelerate the vehicle to the first speed at a second acceleration degree which is gentler than the first acceleration degree when the driver is gripping the steering wheel while the vehicle is decelerated to be closer to the second speed and after the vehicle has reached the first reference location.

23. The vehicle control device according to claim 22,
wherein the processor executes the computer-readable instructions to:
cause the vehicle to travel at the first speed in a case where the driver is gripping the steering wheel while the vehicle is traveling on a curved road and accelerates the vehicle in a case where the vehicle has reached a second reference location set on the basis of an exit of a curve or a spot near the exit of a curve,
accelerate the vehicle to the first speed at the first acceleration degree in a case where a time period from a first time to a second time is equal to or longer than a threshold when the vehicle is decelerated to be closer to the second speed and the driver is gripping the steering wheel, and
accelerate the vehicle at the second acceleration degree in a case where the time period from the first time to the second time is shorter than the threshold when the vehicle is decelerated to be closer to the second speed and the driver is gripping the steering wheel,
the first time is a time when the speed of the vehicle reaches the first speed in a case where it is assumed that the vehicle is accelerated at the first acceleration degree, and
the second time is a time when the vehicle reaches the second reference location in a case where the vehicle has traveled at the first speed from the first time.

24. The vehicle control device according to claim 14,
wherein the first speed plan is a plan in which the speed of the vehicle is decelerated to a first speed, the vehicle is caused to travel at the first speed during a first time period, and then the vehicle is accelerated, and
the controller
cause the speed of the vehicle to follow a speed prescribed in the first speed plan at the time of (i) and causes the speed of the vehicle to follow a speed prescribed in a speed plan different from the first speed plan at the time of (ii) when the driver is gripping the steering wheel and the speed of the vehicle is lower than the speed prescribed in the first speed plan in a case where the vehicle is caused to travel on the basis of the second speed plan, in which
(i) indicates that a time period from a first time point when the speed of the vehicle has reached the first speed to an end point of the first time period is equal to or longer than a threshold in a case where it is assumed that the speed of the vehicle is caused to match the first speed at a predetermined acceleration degree, and
(ii) indicates that the time period from the first time point when the speed of the vehicle has reached the first speed to the end point of the first time period is shorter than the threshold in a case where it is assumed that the speed of the vehicle is caused to match the first speed at the predetermined acceleration degree.

25. A vehicle control method in which a computer executes
processing of recognizing surrounding circumstances of a vehicle,
processing of determining whether or not a driver of the vehicle is gripping a steering wheel of the vehicle,
processing of controlling a speed of the vehicle and steering of the vehicle on the basis of the surrounding circumstances,
processing of causing the vehicle to travel according to a first speed plan in a case where the driver is gripping the steering wheel and causing the vehicle to travel according to a second speed plan for causing the vehicle to travel at a speed lower than a speed according to the first speed plan in a case where the driver is not gripping the steering wheel while the vehicle is traveling on a curved road, in which
the first speed plan and the second speed plan are information indicating transition of the speed of the vehicle when traveling on the curved road, and
processing of switching the second speed plan to the first speed plan and causing the vehicle to travel on the basis of the first speed plan when it is determined that the driver has gripped the steering wheel in a case where the driver is not gripping the steering wheel and the vehicle is caused to travel on the curved road according to the second speed plan.

26. A non-transitory computer storage medium storing a program for causing a computer to execute
processing of recognizing surrounding circumstances of a vehicle,
processing of determining whether or not a driver of the vehicle is gripping a steering wheel of the vehicle,
processing of controlling a speed of the vehicle and steering of the vehicle on the basis of the surrounding circumstances,
processing of causing the vehicle to travel according to a first speed plan in a case where the driver is gripping the steering wheel and causing the vehicle to travel according to a second speed plan for causing the vehicle to travel at a speed lower than a speed according to the first speed plan in a case where the driver is not gripping the steering wheel while the vehicle is traveling on a curved road, in which
the first speed plan and the second speed plan are information indicating transition of the speed of the vehicle when traveling on the curved road, and
processing of switching the second speed plan to the first speed plan and causing the vehicle to travel on the basis of the first speed plan when it is determined that the driver has gripped the steering wheel in a case where the driver is not gripping the steering wheel and the vehicle is caused to travel on the curved road according to the second speed plan.
